(19) United States
(12) Patent Application Publication
(10) Pub. No.: US 2021/0277912 A1
(43) Pub. Date: Sep. 9, 2021

(54) ELECTRIC PUMP WITH JACKET

(71) Applicant: DAB PUMPS S.P.A., Mestrino (IT)

(72) Inventors: Francesco SINICO, Montecchio Maggiore (IT); Pietro CAILOTTO, Trissino (IT); Michele CAPPOCCHIN, Mestrino (IT); Mattia CASAGRANDE, Vicenza (IT); Luca CALORE, Creazzo (IT)

(73) Assignee: DAB PUMPS S.P.A., Mestrino (IT)

(21) Appl. No.: 17/195,812

(22) Filed: Mar. 9, 2021

(30) Foreign Application Priority Data
Mar. 9, 2020 (IT) 102020000004882

(51) Int. Cl. F04D 29/40; F04D 13/06; F04D 13/16; F04D 29/00; F04D 29/043; F04D 29/60

(52) U.S. Cl. CPC F04D 29/406; F04D 13/06; F04D 29/605; F04D 29/007; F04D 29/043; F04D 13/16

(57) ABSTRACT

An electric pump for moving a liquid, comprising a containment jacket which encloses:
a mechanical section, which comprises an assembly for moving the liquid which comprises one or more impellers, interleaved by diffusers, keyed on a driving shaft,
an electromechanical section, comprising an electric motor, contained in a shell and comprising in turn a rotor and a stator that surrounds the rotor, the rotor being keyed on the driving shaft,
the electric pump comprising, at the ends of the jacket, a first cover and a second cover, the second cover having an intake port and a delivery port which are fluidically connected to the mechanical section.

The jacket is provided monolithically.

The present invention relates to an electric pump with jacket.

Currently, vertical surface electric pumps are known and widespread which comprise an external containment jacket which encloses:
a mechanical section, which comprises an intake port and a delivery port, to which the intake and delivery ducts are connected, and contains one or more impellers, interleaved by diffusers keyed on a driving shaft adapted to rotate them, for the movement of the liquid,
an electromechanical section, comprising an electronic board for controlling the electric pump and an electric motor, contained in a shell and comprising in turn a rotor keyed on the driving shaft and a stator which surrounds said rotor.

In the present description, the expression “vertical electric pump” means an electric pump that has a vertical configuration for use and a vertical axis of extension, with the mechanical section in its lower part and the electromechanical section in its upper part, above the mechanical section.

Normally, the external jacket is made of metallic material and/or plastic material and has a substantially tubular shape, with a cylindrical extension.

This background art has some drawbacks.

The external jacket is often provided by means of at least two complementary parts, to be connected during the assembly of the electric pump:
a first part, adapted to contain substantially the mechanical section,
a second part, which lies above the first one in the configuration for use of the electric pump and is adapted to contain substantially the electromechanical section.

The presence of two parts causes a long and cumbersome assembly process and the need to fix these two parts to one another and to an upper cover and to the pump body, usually at the interface between the mechanical section and the electromechanical section.

Moreover, a jacket in two parts also causes a production process of the jacket which is long, cumbersome and constituted by multiple successive steps.

Furthermore, in vertical electric pumps of the known type the electronic board can be connected to the electric motor:
directly, by means of connectors, and therefore arranged adjacent to the motor,
indirectly, by means of cables.

In both cases, the board is contained in an assembly which must be close to the electromechanical section and in contact with a surface inside which the pumping liquid flows for its cooling.

This leads to considerable and complex space occupations of the electric pump.

Finally, in vertical electric pumps of the known type the external jacket:
does not allow the drainage of any liquid that may have seeped through the mechanical seal, located at the interface between the mechanical section and the electromechanical section
or allows the drainage of such liquid, but the installation technician/user is unable to detect any tightness problems of the electric pump, except by direct visual contact with the section from which the liquid is seeping.

The aim of the present invention is to provide an electric pump that is capable of improving the background art in one or more of the aspects mentioned above.

Within this aim, an object of the invention is to provide an electric pump with an external containment jacket that has a production process of the jacket and of the entire electric pump that is easier and quicker than similar electric pumps of the known type.

Another object of the invention is to provide an electric pump that has a jacket which allows the fixing of the electronic board so as to reduce the overall space occupations of the electric pump with respect to similar electric pumps of the known type.

Another object of the invention is to provide an electric pump that allows the draining of any liquid that has seeped through the mechanical seal, at the interface between the mechanical section and the electromechanical section, and allows the installation technician/user to become aware of the tightness problem without direct visual contact with the affected section.

A further object of the present invention is to overcome the drawbacks of the background art in a manner that is alternative to any existing solutions.

Another object of the invention is to provide an electric pump that is highly reliable, relatively easy to provide and at competitive costs.

This aim and these and other objects which will become better apparent hereinafter are achieved by a vertical surface electric pump, for the movement of a liquid, which comprises a containment jacket which encloses:
a mechanical section, which comprises an assembly for moving said liquid which comprises one or more impellers, interleavedby diffusers, keyed on a driving shaft,
an electromechanical section, comprising an electric motor, contained in a shell and comprising in turn a rotor and a stator that surrounds said rotor, said rotor being keyed on said driving shaft,

said electric pump comprising, at the ends of said jacket, a first cover and a second cover, said second cover having an intake port and a delivery port which are fluidically connected to said mechanical section, said electric pump being characterized in that said jacket is provided monolithically.

Further characteristics and advantages of the invention will become better apparent from the description of preferred but not exclusive embodiments of the electric pump according to the invention, illustrated by way of non-limiting example in the accompanying drawings, wherein:

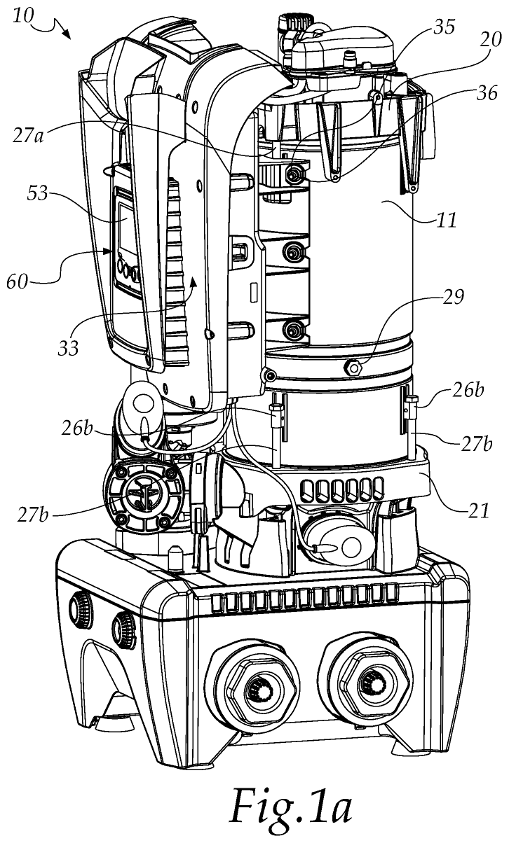

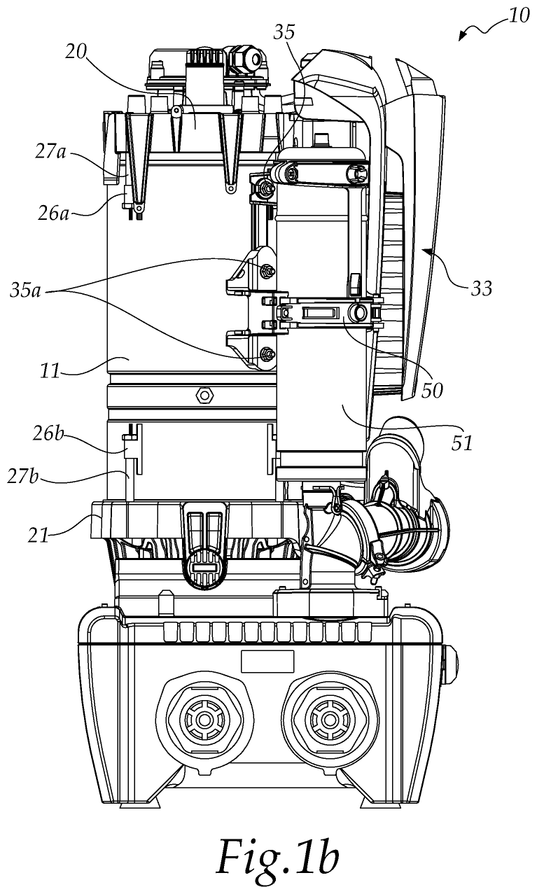

FIGS. 1a and 1b are each a different general perspective view of an electric pump according to the invention;

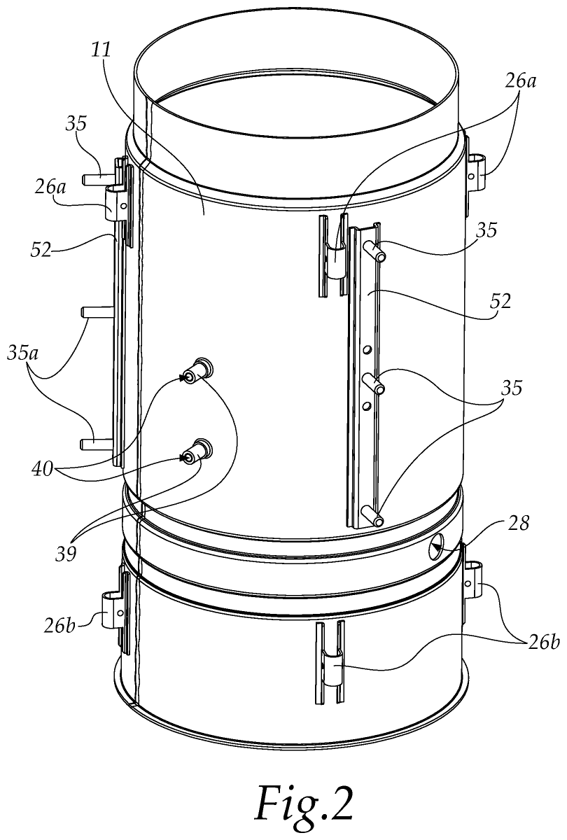

FIG. 2 is a general perspective view of a detail of the electric pump of FIGS. 1a and 1b;

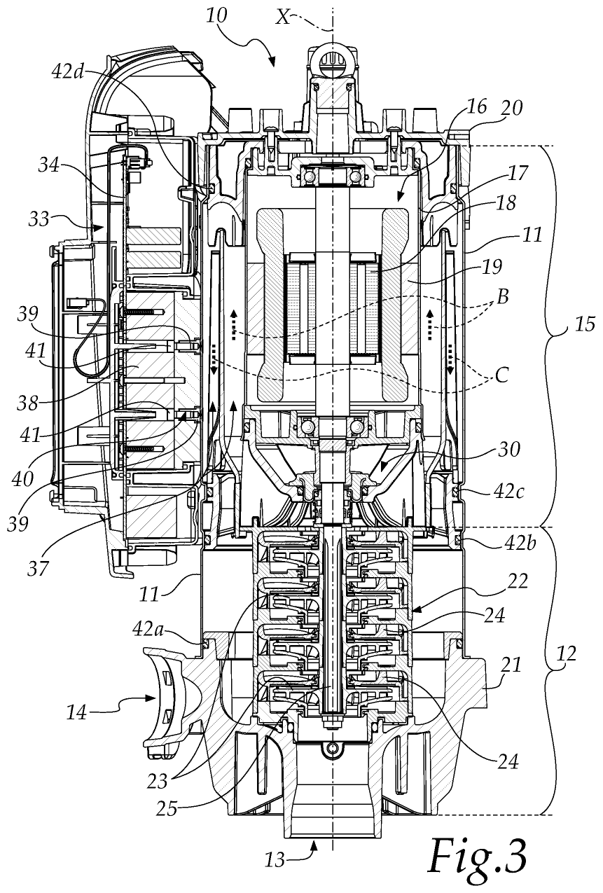

FIG. 3 is a first sectional view of the electric pump of FIGS. 1a and 1b;

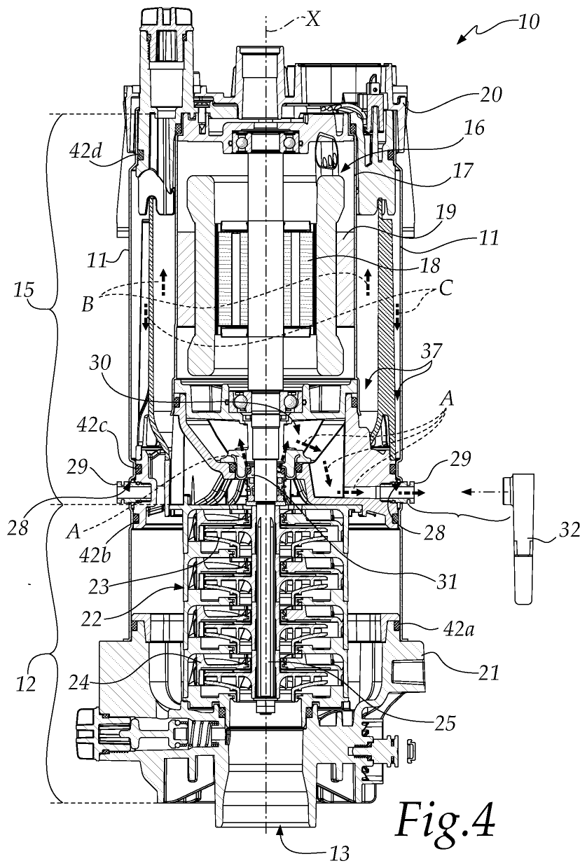

FIG. 4 is a second sectional view of the electric pump of FIGS. 1a and 1b;

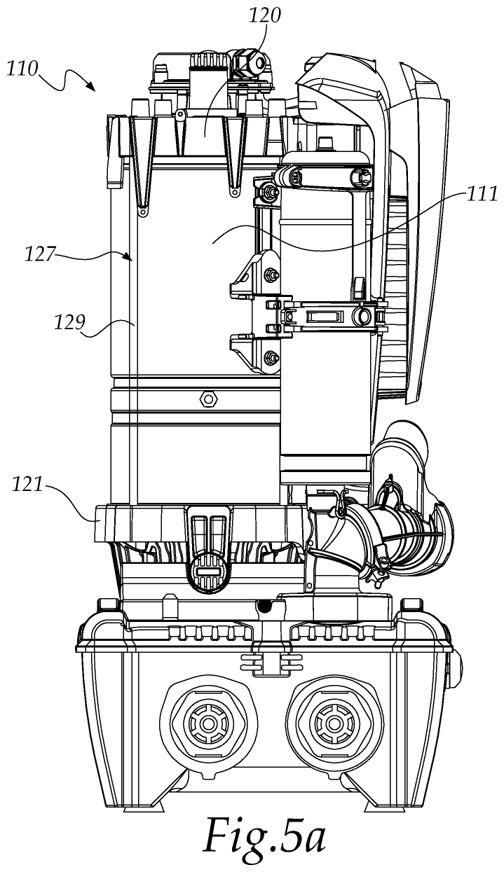

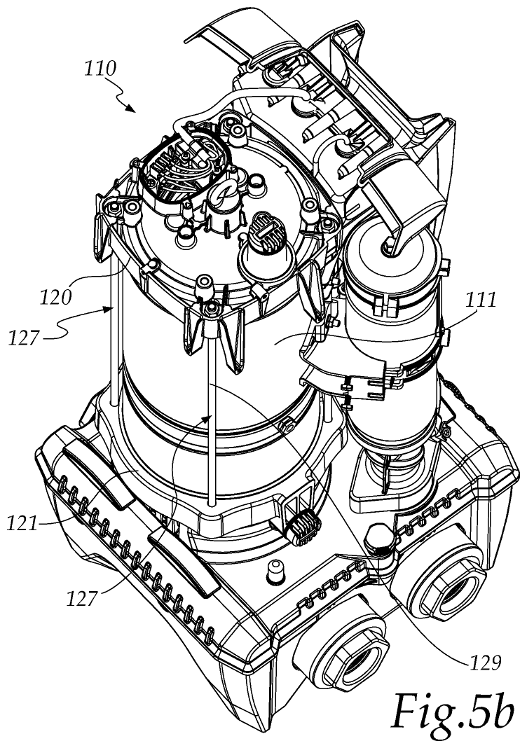

FIGS. 5a and 5b are each a perspective view of an electric pump according to the invention in a second embodiment;

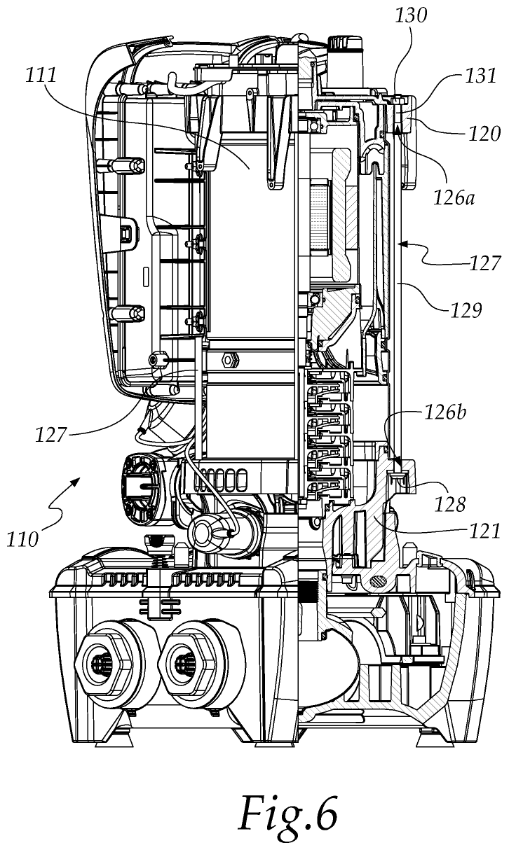

FIG. 6 is a partially sectional perspective view of the electric pump of FIGS. 5a and 5b.

With reference to the figures, an electric pump according to the invention is generally designated by the reference numeral 10 in a first embodiment thereof.

The electric pump 10 shown in FIG. 1 is a vertical surface electric pump.

The electric pump 10 comprises an external containment jacket 11 which encloses, along the axis of extension X of the electric pump 10:
a mechanical section 12, which comprises an assembly 22 for moving the liquid which comprises one or more impellers 23, interleaved by diffusers 24, keyed on a driving shaft 25,
an electromechanical section 15, comprising an electric motor 16, contained in a shell 17 and comprising in turn a rotor 18, which is keyed on the driving shaft 25, and a stator 19 which surrounds the rotor 18.

The jacket 11 is closed, at its ends, by:
a first upper cover 20,
a second lower cover 21, having an intake port 13 and a delivery port 14 for the electric pump 10, which are fluidically connected to the mechanical section 12.

In the case, not shown in the figures, in which the electric pump comprises a single impeller the presence of a diffuser is not necessary.

The jacket 11 has a substantially tubular shape with a substantially cylindrical extension and its axis of extension coincides with the axis of extension X of the electric pump 10.

One of the particularities of the invention resides in that the jacket 11 is provided monolithically, using metallic material, by calendering and welding.

The jacket 11 is made of stainless steel.

The monolithic jacket 11 allows:
firstly, easier and quicker production thereof,
secondly, easier and quicker assembly of the electric pump 10.

This jacket 11 has a plurality of slots 26a, 26b in which elements 27a, 27b for fixing the jacket 11 to the covers, respectively the first cover 20 and the second cover 21, are inserted.

In particular, the slots 26a, 26b:
are provided with a hole the axis of extension of which is substantially parallel to the axis of extension of the jacket 11,
are arranged on the outer lateral surface of the jacket 11, fixed thereto by welding, proximate to a respective cover, the first one 20 or the second one 21.

These fixing elements 27a, 27b are, for example, bolts.

With reference to FIGS. 2 and 4, the jacket 11 has two through holes 28, with an axis of extension that is at right angles to the axis of extension of the jacket 11.

The through holes 28 are at the electromechanical section 15, in a portion 30 thereof, which is proximate to the mechanical section 12 and is substantially comprised between the shell 17 for the containment of the motor 16 and the interface between the mechanical section 12 and the electromechanical section 15.

A nipple 29 is inserted in each through hole 28.

At least one of the nipples 29 is fluidically connected to the portion 30 of the electromechanical section 15.

These nipples 29 facilitate the assembly of the electric pump 10, facilitating the alignment of the jacket 11 with the mechanical section 12 and the electromechanical section 15 and guiding the fixing of the jacket to said sections.

Moreover, the nipples 29 keep the electromechanical section 15 in position inside the jacket 11 during the handling of the unit on the assembly line.

Moreover, the nipple 29 fluidically connected to the portion 30 of the electromechanical section 15 allows the draining, in the direction of the arrows A of FIG. 4, of any liquid that might have seeped through the mechanical seal 31, arranged at the interface between the mechanical section 12 and the electromechanical section 15.

The electric pump 10 can comprise a drainage tray 32 which is connected to the nipple 29 that is connected fluidically to the portion 30 of the electromechanical section 15, in order to collect the liquid that exits from the electric pump 10 through the nipple 29.

Inside the drainage tray 32 there is a sensor, not shown in the figures, which detects the presence of liquid inside it and sends an alarm signal to the electronic board 34 for the control of the electric pump 10.

The signal can be visualized on the display 53 of the pump, allowing the installation technician/user to detect a tightness problem without requiring direct visual contact with the affected section.

The display 53 is contained in the user interface unit 60, which can furthermore have an integrated Wi-Fi module.

In this case, the alarm signal can be sent to the installation technician/user on his mobile phone by means of a dedicated application.

This allows to immediately identify a problem with the mechanical seal and if necessary replace it before it breaks and therefore spills a large amount of liquid toward the motor.

This allows to extend the life of the electric pump 10.

Another particularity of the invention resides in that the electric pump 10 comprises an electronic assembly 33, which contains the electronic board 34 for the control of the electric pump 10 which is fixed to the outer lateral surface of the jacket 11.

In this manner the electronic board 34 is fixed parallel to the axis of extension X of the electric pump 10, reducing the overall space occupations thereof, with respect to similar electric pumps of a known type, ensuring at the same time also the cooling of the board.

In particular, the external lateral surface of the jacket 11 has:
a plurality of elements 35 for fixing it to the electronic assembly 33.
a plurality of elements 35a for fixing a collar 50 for the anchoring of the tank 51 of the electric pump 10.

The fixing elements 35, 35a are, for example, threaded stems with an axis of extension that is at right angles to the axis of extension of the jacket 11, and are welded and extend from plates 52, which in turn are welded to the outer surface of the jacket 11.

The elements 35 are inserted in corresponding holes, not shown in the figures, of the electronic assembly 33 and are fastened thereto by means of nuts 36.

Such collar 50 is of the snap-acting type and holds in position the tank 51 proximate to the jacket 11, once it has been closed.

The electric pump 10 has a wet portion 37, inside the electromechanical section 15, which is separated from the portion 30 and surrounds the shell 17.

The wet portion 37 is shaped so as to allow the passage of the pumping liquid between the intake port 13 and the delivery port 14, skimming:
the outer lateral surface of the shell 17 of the motor 16, moving from the intake port 13 toward the first cover 20, in the direction of the arrow B in FIGS. 3 and 4,
the inner lateral surface of the jacket 11, moving from the first cover 20 toward the delivery port 14, in the direction of the arrow C in FIGS. 3 and 4.

The electronic assembly 33 of the electric pump 10 comprises a heat sink 38 which faces the electronic board 34 on one side and the jacket 11 on the other side.

In this manner, the pumping liquid, by moving from the first cover 20 toward the delivery port 14, in the direction of the arrow C in FIGS. 3 and 4, cools the heat sink 38 which faces the outer surface of the jacket 11.

The jacket 11 has one or more elements 39 for the fixing/support/thermal contact of the electronic assembly 33 to the jacket 11.

The elements 39 for the fixing/support/thermal contact of the electronic assembly 33 to the jacket 11 are, for example, pins with an internal dead hole 40, the axis of extension of which coincides with the axis of extension of the pin and which are welded to the jacket 11 with their axis of extension at right angles to the axis of extension of the jacket 11. The pins 39 are inserted in corresponding through holes of the heat sink 38 and fastened to it by means of respective screws 41, which in turn are inserted in the holes 40 of the pins 39.

Such pins 39 are two in the example shown in the figures.

Another particularity of the invention resides in that the jacket 11 has such a shape as to provide a mechanical seal with a plurality of corresponding sealing elements 42a, 42b, 42c, 42d, arranged along the axis of extension X of the electric pump 10 inside the jacket 11 at different cross-sections thereof.

The sealing elements are O-rings, respectively:
a first sealing element 42a, which is arranged substantially at the interface region between the second cover 21 and the jacket 11,
a second sealing element 42b and a third sealing element 42c, which are arranged at/proximate to the interface between the mechanical section 12 and the electromechanical section 15,
a fourth sealing element 42d, which is arranged substantially at the interface portion between the first cover 20 and the jacket 11.

In a further embodiment, shown in FIGS. 5a, 5b and 6, the electric pump according to the invention is generally designated by the reference numeral 110.

The electric pump 110 is similar to the electric pump described previously, but unlike it the jacket 111 is fixed simultaneously to the first cover 120 and to the second cover 121 by means of a plurality of tension members 127.

In particular, each one of these tension members 127 has a stem 129 that is comparable in length with the distance between the two covers, the first one 120 and the second one 121, considering a direction parallel to the axis of extension of the electric pump.

The first cover 120 is provided with a plurality of first holes 126a, which correspond to a plurality of second holes 126b, provided in the second cover 121, so as to form pairs of corresponding first holes 126a and second holes 126b.

Each tension member 127 crosses, with its stem 129, a respective pair of holes 126a-126b and has, for the fastening of the two covers 120 and 121 to the jacket 111:
at a first end, a wider head 128, proximate to/at the second hole 126b
at a second threaded end 131, which is opposite the first end, a nut 130 which is screwed to it, proximate to/at the first hole 126a.

Due to the interference between the wider head 128 or the nut 130 and the rim of the corresponding hole 126b or 126a, a connection between the two covers 120 and 121 and the fixing thereof to the jacket 111 is produced.

In practice it has been found that the invention achieves the intended aim and objects, providing an electric pump with external containment jacket that has an easier and quicker process for the production thereof and of the entire electric pump than similar electric pumps of the known type.

The invention provides an electric pump which allows the fixing of the electronic board assembly and of the collar for the anchoring of the tank directly on the jacket without the use of additional components.

The invention provides an electric pump which has a jacket that allows to reduce the overall space occupations of the electric pump with respect to similar electric pumps of the known type.

Furthermore, the invention provides an electric pump which allows the draining of any liquid that might have seeped through the mechanical seal, at the interface between the mechanical section and the electromechanical section, allowing at the same time the installation technician/user to be aware of the tightness problem without requiring direct visual contact with the affected section.

The invention thus conceived is susceptible of numerous modifications and variations, all of which are within the scope of the appended claims; all the details may furthermore be replaced with other technically equivalent elements.

In practice, the materials used, so long as they are compatible with the specific use, as well as the contingent shapes and dimensions, may be any according to the requirements and the state of the art.

The disclosures in Italian Patent Application No. 102020000004882 from which this application claims priority are incorporated herein by reference.

What is claimed is:

1. An electric pump for moving a liquid, comprising a containment jacket which encloses:
a mechanical section, which comprises an assembly for moving said liquid which comprises one or more impellers, interleaved by diffusers, keyed on a driving shaft,
an electromechanical section, comprising an electric motor, contained in a shell and comprising in turn a rotor and a stator that surrounds said rotor, said rotor being keyed on said driving shaft,
said electric pump comprising, at ends of said containment jacket, a first cover and a second cover, said second cover having an intake port and a delivery port which are fluidically connected to said mechanical section, said electric pump being characterized in that said containment jacket is provided monolithically.

2. The electric pump according to claim 1, wherein said containment jacket has a substantially tubular shape with a substantially cylindrical extension and an axis of extension thereof substantially coincides with an axis of extension of said electric pump.

3. The electric pump according to claim 1, wherein said jacket is made of a metallic material by calendering and welding.

4. The electric pump according to claim 1, wherein said containment jacket has a plurality of slots in which elements for fixing said jacket to said first cover and to said second cover are inserted, said slots:
being provided with a hole an axis of extension of which is substantially parallel to the axis of extension of said containment jacket,
being arranged on a outer lateral surface of said containment jacket, proximate to a respective cover.

5. The electric pump according to claim 2, wherein said containment jacket is provided with one or more through holes, an axis of extension of which is perpendicular to the axis of extension of said containment jacket, said one or more through holes being located at said electromechanical section, in a portion thereof, said portion being proximate to said mechanical section and being substantially comprised between said shell for the containment of said motor and the interface between said mechanical section and said electromechanical section.

6. The electric pump according to claim 5, wherein a nipple is inserted in each one of said one or more through holes.

7. The electric pump according to claim 5, further comprising at least one nipple which is fluidically connected to said portion of said electromechanical section.

8. The electric pump according to claim 7, further comprising a drainage tray which is connected to said at least one nipple that is connected fluidically to said portion of said electromechanical section.

9. The electric pump according to claim 1, further comprising an electronic assembly, which contains an electronic board for control of said motor which is fixed to an outer lateral surface of said containment jacket.

10. The electric pump according to claim 9, wherein the outer lateral surface of said containment jacket has:
a plurality of fixing elements for fixing it to said electronic assembly,
and/or a plurality of fixing elements for fixing a collar for the anchoring of a tank of said electric pump.

11. The electric pump according to claim 10, wherein said fixing elements are threaded stems which are fixed to said containment jacket, with an axis of extension that is perpendicular to the axis of extension of said containment jacket.

12. The electric pump according to claim 1, further comprising a wet portion inside said electromechanical section, which is separated from said portion of said electromechanical section and surrounds said shell, said wet portion being shaped so as to allow a passage of said liquid between said intake port and said delivery port, said liquid skimming:
the outer lateral surface of said shell, moving from said intake port toward said first cover,
the inner lateral surface of said containment jacket, moving from said first cover toward said delivery port.

13. The electric pump according to claim 9, wherein said electronic assembly comprises a heat sink which faces on one side said electronic board and on another side said containment jacket.

14. The electric pump according to claim 9, wherein said containment jacket is provided with one or more fixing elements for the fixing/support/thermal contact of said electronic assembly with respect to said containment jacket.

15. The electric pump according to claim 14, wherein said fixing/support/thermal contact elements are pins with an internal dead hole the axis of extension of which coincides with the axis of extension of the respective one of said pins, said pins being welded to said jacket with their axis of extension at right angles to the axis of extension of said containment jacket, said pins being inserted in corresponding through holes of said heat sink and being fastened to it by means of respective screws, each one of said screws being inserted in said internal dead hole of said pins.

16. The electric pump according to claim 1, wherein said containment jacket has such a shape as to provide a mechanical seal with a plurality of corresponding sealing elements arranged along the axis of extension of said electric pump, inside said containment jacket at different cross-sections of the latter.

17. The electric pump according to claim 1, wherein said containment jacket is fixed simultaneously to said first cover and to said second cover by means of a plurality of tension members.

18. The electric pump according to claim 17, wherein each one of said tension members has a stem that is comparable in length with the distance between said first cover and said second cover.

19. The electric pump according to claim 1, wherein said first cover is provided with a plurality of first holes which correspond to a plurality of second holes provided in said second cover so as to form pairs of matching first holes and second holes,
each one of said tension members crossing, with said stem, a respective pair of holes and having:
at a first end, a wider head,
at a second threaded end, which is opposite the first end, a nut which is screwed to it.

20. A tray for the drainage of liquid that exits from a containment jacket of an electric pump, wherein it can be connected fluidically to said containment jacket of said electric pump via a nipple.

21. The tray according to claim 20, wherein it is provided internally with a sensor for detecting presence of liquid.
